(19) United States
(12) Patent Application Publication
(10) Pub. No.: US 2023/0038553 A1
(43) Pub. Date: Feb. 9, 2023

(54) WINDROWER WITH CONTROLLER TO AUTOMATICALLY DEFINE CONDITIONER SETTINGS

(71) Applicant: CNH Industrial America LLC, New Holland, PA (US)

(72) Inventors: Benjamin Steidinger, Germansville, PA (US); Jeffrey B. Fay, II, Oxford, PA (US)

(73) Assignee: CNH Industrial America LLC, New Holland, PA (US)

(21) Appl. No.: 17/397,377

(22) Filed: Aug. 9, 2021

(51) Int. Cl. A01D 41/127; A01D 43/10; A01D 82/00

(52) U.S. Cl. CPC A01D 41/1277; A01D 43/10; A01D 82/00

(57) ABSTRACT

A windrower system includes: a windrower including: a chassis; a cutter carried by the chassis and configured to cut crop material; and an adjustable conditioner carried by the chassis behind the cutter and configured to condition crop material cut by the cutter; and a controller operably coupled to the conditioner and including a memory. The controller is configured to: receive a crop type signal corresponding to a crop type; recall at least one conditioner operating parameter from the memory based at least partially on the received crop type signal; and output a conditioner adjustment signal to the conditioner to adjust the conditioner to the recalled at least one conditioner operating parameter.

### FIELD OF THE INVENTION

The present invention pertains to agricultural vehicles and, more specifically, to windrowers.

### BACKGROUND OF THE INVENTION

An agricultural vehicle known as a “windrower” is used to cut and place crop material into a windrow for subsequent harvesting or baling by another agricultural machine in a secondary operation. A windrower can be self-propelled and may include a chassis, wheels supporting the chassis, a prime mover, a cab, and a detachable header such as a sicklebar header or a draper header for cutting and placing the crop material on the field in the windrow. Some of the crops processed by windrowers include hay, forage, and other small-grain crops. Many windrowers include a conditioner, such as a pair of conditioning wheels, to condition the cut crop material before being placed in the windrow. While windrowers are generally effective at cutting crop material and forming windrows, efficient operation of the windrower depends on the correct settings for the conditions.

What is needed in the art is a windrower that can overcome at least some of the disadvantages of known windrowers.

### SUMMARY OF THE INVENTION

Exemplary embodiments disclosed herein provide a windrower system with a controller that can adjust one or more conditioner operating parameters based at least partially on a crop type signal.

In some exemplary embodiments provided according to the present disclosure, a windrower system includes: a windrower includes: a chassis; a cutter carried by the chassis and configured to cut crop material; and an adjustable conditioner carried by the chassis behind the cutter and configured to condition crop material cut by the cutter; and a controller operably coupled to the conditioner and including a memory. The controller is configured to: receive a crop type signal corresponding to a crop type; recall at least one conditioner operating parameter from the memory based at least partially on the received crop type signal; and output a conditioner adjustment signal to the conditioner to adjust the conditioner to the recalled at least one conditioner operating parameter.

In some embodiments, a method of adjusting a conditioner of a windrower system is provided. The conditioner is configured to condition crop material cut by a cutter and operably coupled to a controller including a memory. The method is performed by the controller and includes: receiving a crop type signal corresponding to a crop type; recalling at least one conditioner operating parameter from the memory based at least partially on the received crop type signal; and outputting a conditioner adjustment signal to the conditioner to adjust the conditioner to the recalled at least one conditioner operating parameter.

One possible advantage that may be realized by exemplary embodiments disclosed herein is that one or more conditioner operating parameters that have been found to be effective for a specific crop type can be loaded into the memory and conveniently recalled later to automatically adjust the conditioner.

Another possible advantage that may be realized by exemplary embodiments disclosed herein is that the controller can be configured to also receive one or more other input signals and recall one or more conditioner operating parameters based on the other input signal(s).

Another possible advantage that may be realized by exemplary embodiments disclosed herein is that a user does not need to learn and remember effective conditioner operating parameters when cutting and conditioning crop types that the user is unfamiliar with and/or does not normally windrow.

Another possible advantage that may be realized by exemplary embodiments disclosed herein is that a display can present the conditioner operating parameter(s), which a user may then utilize to manually adjust the conditioner.

### BRIEF DESCRIPTION OF THE DRAWINGS

For the purpose of illustration, there are shown in the drawings certain embodiments of the present invention. It should be understood, however, that the invention is not limited to the precise arrangements, dimensions, and instruments shown. Like numerals indicate like elements throughout the drawings. In the drawings:

FIG. 1 illustrates a side view of an exemplary embodiment of a windrower provided according to the present disclosure;

FIG. 2 illustrates a rear view of a header of the windrower of FIG. 1 including a cutter and a conditioner;

FIG. 3 illustrates an exemplary embodiment of a display presenting a conditioner setting menu that may be used to adjust the conditioner of the windrower of FIGS. 1 and 2 in accordance with the present disclosure;

FIG. 4 illustrates the display of FIG. 3 with the conditioner setting menu after a basic setup mode has been selected and a plurality of crop types are presented on the display;

FIG. 5 illustrates the display of FIG. 4 with the conditioner setting menu after one of the crop types has been selected to output a crop type signal to a controller, which recalls conditioner operating parameters from a memory for operating the conditioner based on the crop type signal according to the present disclosure;

FIG. 6 illustrates the display of FIG. 3 with the conditioner setting menu after an advanced setup mode has been selected and some user input has been entered;

FIG. 7 illustrates the display of FIG. 6 with the conditioner setting menu after the user has input requested input and the controller has recalled conditioner operating parameters based on the crop type and other user input; and

FIG. 8 is a flow chart illustrating an exemplary embodiment of a method of adjusting a conditioner of a windrower system, provided in accordance with the present disclosure.

### DETAILED DESCRIPTION OF THE INVENTION

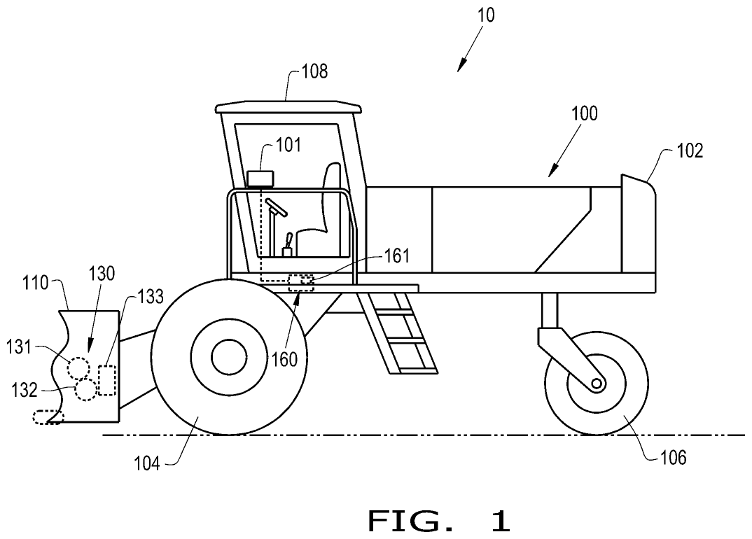

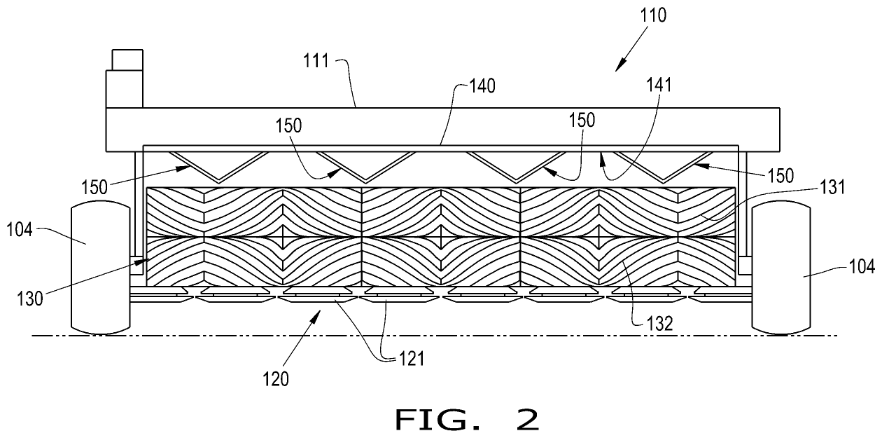

Referring now to the drawings, and more particular to FIGS. 1-2, there is shown a windrower system 10 with an agricultural vehicle 100 in the form of a self-propelled windrower 100. However, the agricultural vehicle 100 may be in the form of any desired windrower or swather, e.g., a windrower towed by another vehicle such as a tractor. The windrower 100 may generally include a chassis 102, front and rear wheels 104, 106, a prime mover (not shown), a cab 108, and a header 110 removably connected to the chassis 102. The prime mover may drive the front wheels 104. The rear wheels 106 may be configured as steerable, follower or caster wheels 106. If the windrower 100 is not self-propelled, the prime mover may be a part of the towing vehicle and provide the power to propel both the towing vehicle and the windrower 100. The header 110 may generally include a cutter 120, such as a rotary disc-type cutter or sickle bar, and a conveyor or feeder mechanism. The header 110 can be in the form of any desired header. A display 101, such as a touchscreen display, may be disposed in the cab 108 that allows a user to monitor and control operation of the windrower 100.

Crop material is severed from the ground by the cutter 120 whereupon it is directed toward and engaged by a conditioner 130. The cutter 120 may comprise a plurality of rotary disc cutter modules 121 arranged so that adjacent pairs of modules 121 counter-rotate. Adjacent pairs of the modules 121 rotate so that the modules 121 converge crop material therebetween while other adjacent pairs of modules 121 divergingly rotate so that cut crop is directed away from the space between the modules 121. Consequently, the crop material being directed toward the conditioner 130 is concentrated into a number of crop streams generally centered between pairs of convergingly rotating disc cutter modules 121 and less dense in the area downstream of divergingly rotating disc cutter modules 121.

The conditioner 130 is adjustable and may comprise a pair of transversely elongate conditioning rolls 131, 132 as shown, or it may comprise a flail-type conditioner in which crop passes between a single roll with radially arranged flails and a closely proximate adjacent surface in order to crush the crop material. The conditioning rolls 131, 132 are closely spaced apart on parallel, transverse axes such that a gap is created therebetween through which crop material passes. The crop material is then ejected rearwardly from the conditioner rolls 131, 132 in a plurality of airborne streams along a trajectory whereupon it falls to the ground in a mat. A swathgate or swathboard 140 may be provided to allow alteration of the crop trajectory and thereby control the configuration of the resultant mat of crop material on the ground behind the windrower 100. Movement of the crop material through the conditioner 130 typically does little to laterally redistribute the individual streams of crop material, thus the mat of crop material deposited on the ground would be of non-uniform density without additional crop movement guides.

The swathboard 140 comprises a generally planar crop guide surface 141 oriented slightly above the trajectory of crop material ejected from the conditioner rolls 131, 132. The swathboard 140 may be movable so that the guide surface 141 may be angularly positioned to interact to varying degrees with the streams of crop material and thereby influence the trajectory of the crop material streams discharged from the conditioner 130. A fixed-position swathboard may also be used. In some embodiments, one or more deflectors 150 may also be included to further affect the trajectory of the discharged crop material.

In known windrowers, the operating parameters of the conditioner are generally set by the user. Users generally set the operating parameters based on their experience with a crop type and/or certain characteristics of the standing crop, such as stem diameter. If the user is not familiar with a certain crop type and/or the characteristics of the standing crop deviate from previous collection, a user may not know the most efficient operating parameters for the conditioner. The user may then be frustrated if the chosen operating parameters detrimentally affect conditioning and/or if the user seeks efficient operating parameters for the conditions and finds conflicting and/or unreliable information.

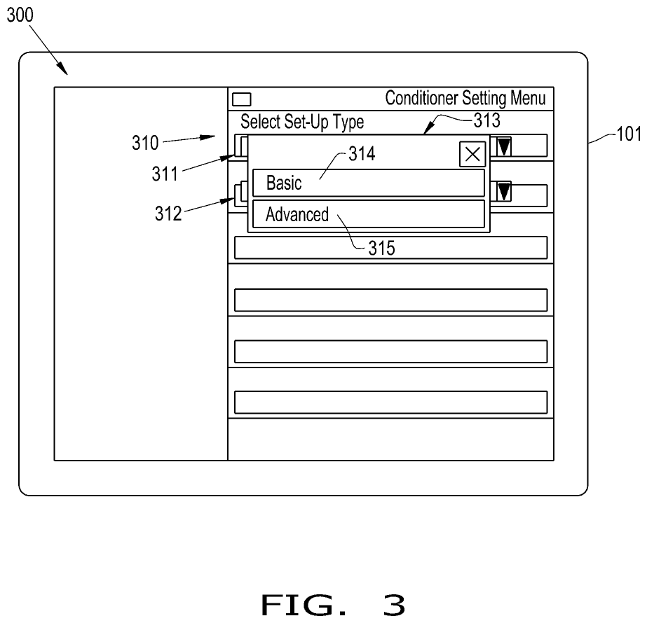

To address some of the previously described issues, and referring now to FIGS. 3-7 as well, the windrower system 10 includes a controller 160 that includes a memory 161. The controller 160 is operably coupled to the conditioner 130, such as a roll actuator 133 of the conditioner 130 that is coupled to one or both of the conditioning rolls 131, 132 and configured to move at least one of the conditioning rolls 131, 132. While the controller 160 is illustrated as being carried by the chassis 102 of the windrower 100, i.e., the controller 160 is a windrower controller, in some embodiments the controller 160 is not carried by the chassis 102 of the windrower 100. For example, the controller 160 may be included in a towing vehicle towing the windrower 100 or be part of a device that remotely controls the windrower 100, such as a smartphone. In such scenarios, the controller 160 may be operably coupled to the conditioner 130 via respective communication modules. The controller 160 is configured to receive a crop type signal corresponding to a crop type; recall at least one conditioner operating parameter from the memory 161 based at least partially on the received crop type signal; and output a conditioner adjustment signal to the conditioner 130 to adjust the conditioner 130 to the recalled at least one conditioner operating parameter.

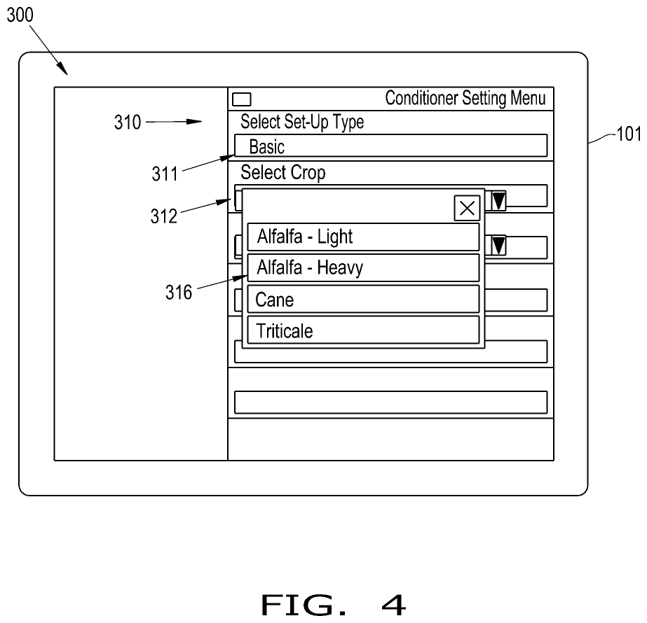

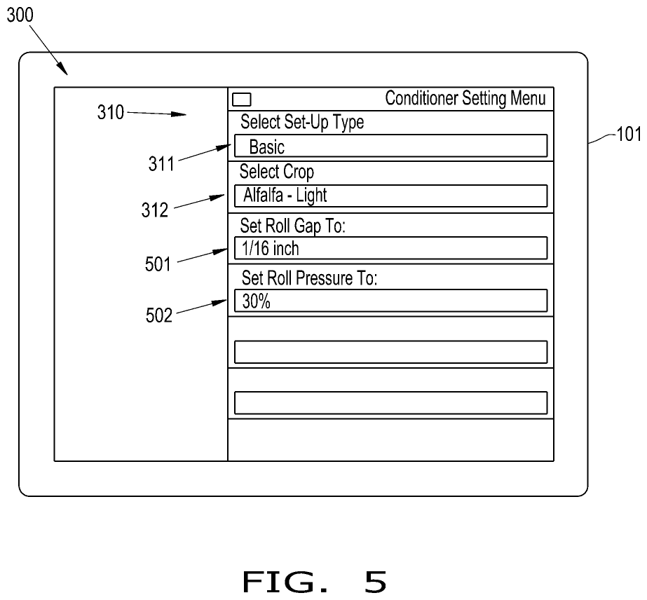

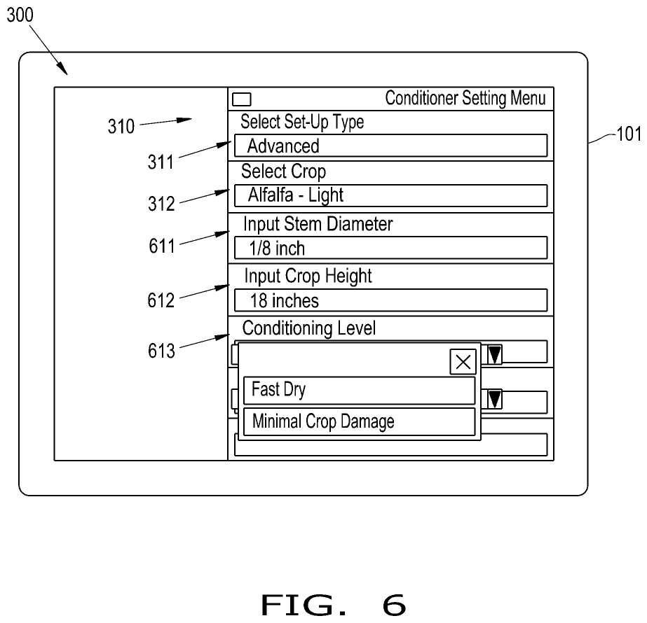

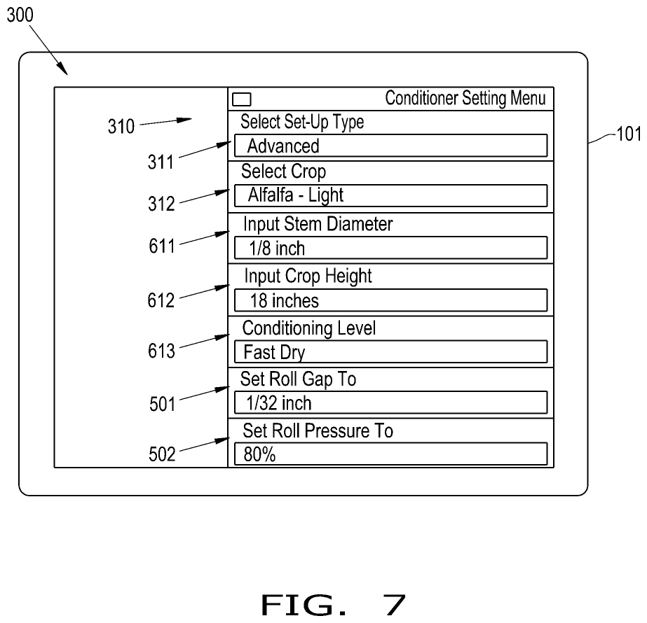

The controller 160 may be configured to receive the crop type signal from a variety of sources. As illustrated in FIGS. 3-7, the controller 160 may be operably coupled to the display 101, which can present a user interface 300 with a conditioner setting menu 310. The conditioner setting menu 310 can present various interactable graphics 311, 312 that a user can select. As illustrated in FIGS. 3-7, one of the graphics 311 may be a setup selection graphic that, when selected, causes the display 101 to present a setup sub-menu 313 with a plurality of selectable graphics 314, 315. The selectable graphic 314, when selected, may cause the conditioner setting menu 310 to enter a basic setup mode, as illustrated in FIGS. 4-5, and the selectable graphic 315, when selected, may cause the conditioner setting menu 310 to enter an advanced setup mode, as illustrated in FIGS. 6-7. In both the basic setup mode and the advanced setup mode, the conditioner setting menu 310 presents a crop type graphic 316. The advanced setup mode may provide additional selectable graphics 611, 612, 613 (illustrated in FIGS. 6-7) that a user can further select to provide additional input to the controller 160, as will be described further herein. Similarly to the controller 160, while the display 101 is illustrated and described as being carried by the chassis 102 of the windrower 100, in some embodiments the display 101 is not carried by the chassis 102 and is, instead, part of a remote device, e.g., a smartphone.

When the conditioner setting menu 310 is in the basic setup mode, as illustrated in FIGS. 4-5, the user only needs to select a crop type from the crop type graphic 316. As illustrated in FIGS. 4-5, the crop type is selected as “Alfalfa-Light”, corresponding to the crop type (alfalfa) being cut and conditioned as well as the density of alfalfa in the field (light). After the user selects the “Alfalfa-Light” graphic, the display 101 outputs the crop type signal corresponding to the crop type (light alfalfa) to the controller 160.

The controller 160, after receiving the crop type signal, recalls one or more conditioner operating parameters from the memory 161 based at least partially on the received crop type signal corresponding to the crop type. For example, the controller 160 may be configured to recall the conditioner operating parameter(s) from a lookup table stored in the memory 161 that associates one or more conditioner operating parameters with a specific crop type. The lookup table may be pre-installed in the memory 161 by a manufacturer; alternatively, or in addition, the lookup table may be installed and/or edited in the memory 161 by a user. When light alfalfa is the crop type, for example, the associated conditioner operating parameters in the lookup table may be a defined gap between the conditioning rolls 131, 132 of ⅙^{th} of an inch and/or a defined pressure exerted by the conditioning rolls 131, 132, e.g., 30% of a maximum pressure. After recalling the conditioner operating parameter(s), the controller 160 outputs a conditioner adjustment signal to the conditioner 130, e.g., the roll actuator 133, to adjust the conditioner 130, e.g., the conditioning rolls 131, 132, to the recalled conditioner operating parameter(s). For example, the roll actuator 133 may move one or both of the conditioning rolls 131, 132 so the defined gap is defined therebetween. Thus, the controller 160 may be configured to recall the conditioner operating parameter(s) from the memory 161 based solely on the received crop type signal, e.g., when in the basic setup mode. In some embodiments, the controller 160 also outputs a conditioner adjustment signal to the display 101 so the display 101 presents one or more conditioner operating parameter graphics 501, 502 presenting the recalled conditioner operating parameters. If desired, the user may consult the conditioner operating parameter graphics 501, 502 to manually adjust the conditioner 130. It should be appreciated that other conditioner operating parameters may be adjusted, including but not limited to a rotation speed of the conditioner 130.

In some embodiments, the controller 160 is further configured to receive at least one crop characteristic signal corresponding to at least one characteristic of crop material, with the recalled conditioner operating parameter(s) also being based on the crop characteristic signal(s). The controller 160 may also be configured to receive a conditioning level signal corresponding to a conditioning characteristic of conditioned crop material, with the recalled conditioner operating parameter(s) also being based on the conditioning level signal. Referring specifically now to FIGS. 6-7, the conditioner setting menu 310 is illustrated in an advanced setup mode with selectable graphics 611, 612, 613. The selectable graphics 611, 612 may be presented for a user to input one or more crop characteristics, including but not limited to a stem diameter and a crop height of the crop material. The user selecting the corresponding crop characteristic of each of the selectable graphics 611, 612 can cause the controller 160 to receive one or more crop characteristic signals corresponding to the crop characteristic(s), which may be output to the controller 160 by the display 101. Similarly, the selectable graphic 613 may be presented for a user to input a conditioning characteristic of conditioned crop material, such as a drying time of conditioned crop material or damage to conditioned crop material as illustrated. The user selecting the corresponding conditioning characteristic of the selectable graphic 613 can cause the controller 160 to receive conditioning level signal corresponding to the conditioning characteristic, which may be output to the controller 160 by the display 101. The controller 160 may then recall the conditioner operating parameter(s), such as from the previously described lookup table stored in the memory 161, based on the crop type signal (crop type) and the crop characteristic signal(s) (crop characteristic(s)) and/or the conditioning level signal (conditioning characteristic). It should thus be appreciated that the recalled conditioner operating parameter(s) can be based on a variety of different parameters to provide the windrower 100 with efficient performance.

From the foregoing, it should be appreciated that the windrower system 10 provided according to the present disclosure has a controller 160 with a memory 161 that can be used to adjust conditioner operating parameters based on the type of crop being conditioned, as well as other parameters. The conditioner operating parameters may be adjusted automatically by the system 10 or manually by a user consulting the conditioner operating parameter(s). The conditioner operating parameter(s) may be loaded into the memory 161 by a manufacturer, who may have a significant amount of data to determine the optimal conditioner operating parameters for specific crop types and other parameters. Thus, the windrower system 10 provided according to the present disclosure alleviates the need for a user to remember how the conditioner 130 should be set for specific crop types and other parameters.

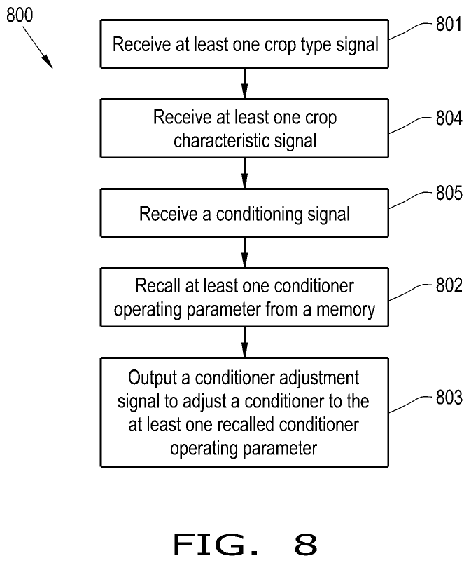

Referring now to FIG. 8, an exemplary embodiment of a method 800 of adjusting the conditioner 130 of the windrower 100 of the windrower system 10 provided according to the present disclosure is illustrated. The method 800 is performed by the controller 160 and includes: receiving 801 the crop type signal corresponding to the crop type; recalling 802 at least one conditioner operating parameter from the memory 161 based at least partially on the received crop type signal; and outputting 803 the conditioner adjustment signal to the conditioner 160 to adjust the conditioner 160 to the recalled conditioner operating parameter(s). In some embodiments, recalling 802 the conditioner operating parameter(s) from the memory 161 is based solely on the received crop type signal. In some embodiments, the method 800 further includes receiving 804 at least one crop characteristic signal corresponding to at least one characteristic of crop material, with the recalled conditioner operating parameter(s) also being based on the crop characteristic signal(s). The method 800 may also include receiving 805 a conditioning level signal corresponding to a conditioning characteristic of conditioned crop material, the recalled conditioner operating parameter(s) also being based on the conditioning level signal.

It is to be understood that the steps of the method 800 are performed by the controller 160 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller 160 described herein, such as the method 800, is implemented in software code or instructions which are tangibly stored on a tangible computer readable medium. The controller 160 loads the software code or instructions via a direct interface with the computer readable medium or via a wired and/or wireless network. Upon loading and executing such software code or instructions by the controller 160, the controller 160 may perform any of the functionality of the controller 160 described herein, including any steps of the method 800 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

1. A windrower system, comprising:
a windrower comprising:
a chassis;
a cutter carried by the chassis and configured to cut crop material; and
an adjustable conditioner carried by the chassis behind the cutter and configured to condition crop material cut by the cutter; and
a controller operably coupled to the conditioner and comprising a memory, the controller being configured to:
receive a crop type signal corresponding to a crop type;
recall at least one conditioner operating parameter from the memory based at least partially on the received crop type signal; and
output a conditioner adjustment signal to the conditioner to adjust the conditioner to the recalled at least one conditioner operating parameter.

2. The windrower system of claim 1, wherein the conditioner comprises a pair of conditioning rolls defining a gap therebetween.

3. The windrower system of claim 2, wherein the at least one conditioner operating parameter comprises at least one of a defined gap between the conditioning rolls or a defined pressure exerted by the conditioning rolls.

4. The windrower system of claim 1, wherein the controller is further configured to receive at least one crop characteristic signal corresponding to at least one characteristic of crop material, wherein the recalled at least one conditioner operating parameter is also based on the at least one crop characteristic signal.

5. The windrower system of claim 4, wherein the at least one characteristic of crop material comprises at least one of a stem diameter of crop material or a height of crop material.

6. The windrower system of claim 1, wherein the controller is further configured to receive a conditioning level signal corresponding to a conditioning characteristic of conditioned crop material, wherein the recalled at least one conditioner operating parameter is also based on the conditioning level signal.

7. The windrower system of claim 6, wherein the conditioning characteristic comprises at least one of drying time of conditioned crop material or damage to conditioned crop material.

8. The windrower system of claim 1, further comprising a display operably coupled to the controller, the display being configured to output the crop type signal to the controller.

9. The windrower system of claim 8, wherein the display is carried by the chassis.

10. The windrower system of claim 1, wherein the controller is configured to recall the at least one conditioner operating parameter from the memory based solely on the received crop type signal.

11. A method of adjusting a conditioner of a windrower system, the conditioner being configured to condition crop material cut by a cutter and operably coupled to a controller comprising a memory, the method being performed by the controller and comprising:
receiving a crop type signal corresponding to a crop type;
recalling at least one conditioner operating parameter from the memory based at least partially on the received crop type signal; and
outputting a conditioner adjustment signal to the conditioner to adjust the conditioner to the recalled at least one conditioner operating parameter.

12. The method of claim 11, wherein the conditioner comprises a pair of conditioning rolls defining a gap therebetween.

13. The method of claim 12, wherein the at least one conditioner operating parameter comprises at least one of a defined gap between the conditioning rolls or a defined pressure exerted by the conditioning rolls.

14. The method of claim 11, further comprising receiving at least one crop characteristic signal corresponding to at least one characteristic of crop material, wherein the recalled at least one conditioner operating parameter is also based on the at least one crop characteristic signal.

15. The method of claim 14, wherein the at least one characteristic of crop material comprises at least one of a stem diameter of crop material or a height of crop material.

16. The method of claim 11, further comprising receiving a conditioning level signal corresponding to a conditioning characteristic of conditioned crop material, wherein the recalled at least one conditioner operating parameter is also based on the conditioning level signal.

17. The method of claim 16, wherein the conditioning characteristic comprises at least one of drying time of conditioned crop material or damage to conditioned crop material.

18. The method of claim 11, wherein the windrower system comprises a display operably coupled to the controller, the display being configured to output the crop type signal to the controller.

19. The method of claim 11, wherein the recalling the at least one conditioner operating parameter from the memory is based solely on the received crop type signal.
